(19) United States
(12) Patent Application Publication
(10) Pub. No.: US 2010/0053604 A1
(43) Pub. Date: Mar. 4, 2010

(54) BROKEN SCREEN DETECTOR

(76) Inventor: Paul Rice, Costa Mesa, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/544,377

(22) Filed: Aug. 20, 2009

Related U.S. Application Data
(60) Provisional application No. 61/093,337, filed on Aug. 31, 2008.

(51) Int. Cl. G01N 21/896

(52) U.S. Cl. 356/239.2

(57) ABSTRACT

Systems and methods that facilitate the detection of a broken or damaged screen in a laser PTV due to impact or shock through the measure or monitoring of continuity or resistivity of a conductive trace applied to the screen. In one embodiment, a screen damage detection system comprises a clear conductive trace applied to the display screen preferably in a serpentine configuration. Damage to the screen is detected when the hole or crack in the screen is sufficiently large to open the conductive trace. In another embodiment, a damage detection system comprises a clear resistive film applied to the screen. The resistance is measured in the X and Y axis to detect changes in the resistance of the coating due to a crack or hole in the screen and disable the laser through a laser enable output signal when a change in resistance greater than a predetermined value is detected.

### CROSS-REFERENCE TO RELATED APPLICATION

This application claims the benefit of provisional application Ser. No. 61/093,337 filed Aug. 30, 2008, which is fully incorporated herein by reference.

### FIELD

The embodiments described herein relate generally to televisions and particularly to laser light source based televisions, and more particularly, to systems and methods that facilitate the detection of a broken or damage screen.

### BACKGROUND INFORMATION

In laser projection televisions (PTVs), a laser light source is used to illuminate images for projection on to the display screen. However, as with other systems using laser light, there remains the potential risk to the user or viewer of excessive exposure to the laser light should the laser light become uncontained. In a laser PTV, containment failure can occur due to a broken or damaged screen. The uncontained laser light could hit the viewer directly in the eye or on the skin, which could result in severe damage to the viewer's eye and/or skin.

Thus, systems and methods that facilitate the detection of a broken or damaged screen are desirable.

### SUMMARY

The embodiments provided herein are directed to systems and methods that facilitate the detection of a broken or damaged screen in a laser PTV due to impact or shock through the measure or monitoring of continuity or resistivity of a conductive trace or coating applied to the screen. In one embodiment, a screen damage detection system for a laser PTV preferably comprises a clear, transparent or translucent conductive trace formed of a clear, transparent or translucent conductive material applied to the display screen preferably in a serpentine configuration. The pitch of the trace is preferably less than half the size of a hole or crack in the screen to be detected. Damage to the screen is detected when the hole or crack in the screen is sufficiently large to open the conductive trace. A laser enabled output signal is used to shut down the laser source to prevent excessive laser light output.

In another embodiment, a damage detection system preferably comprises a clear, transparent or translucent resistive coating or film, such as a thin metallic layer, applied to the screen. The resistance is preferably measured by applying a fixed current and measuring the voltage drop across electrodes positioned along the edges of the screen. A microprocessor, which records the normal resistance in the X and Y axis of the undamaged screen, controls a set of switches to sample the X and Y resistance to detect changes in the resistance of the coating due to a crack or hole in the screen and disable or turn off the laser through a laser enable output signal when a change in resistance greater than a predetermined value is detected.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the example embodiments. Moreover, all illustrations are intended to convey concepts, where relative sizes, shapes and other detailed attributes may be illustrated schematically rather than literally or precisely.

FIG. 1 is a side view schematic of a laser projection television (PTV).

FIG. 2 is a schematic of a control system for the laser PTV shown in FIG. 1 with an integrated screen damage detection system.

FIG. 3 is a plan view schematic of a screen damage detection system.

FIG. 4 is a plan view schematic of an alternate embodiment of a screen damage detection system.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce a screen damage detection circuit for a laser projection television. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

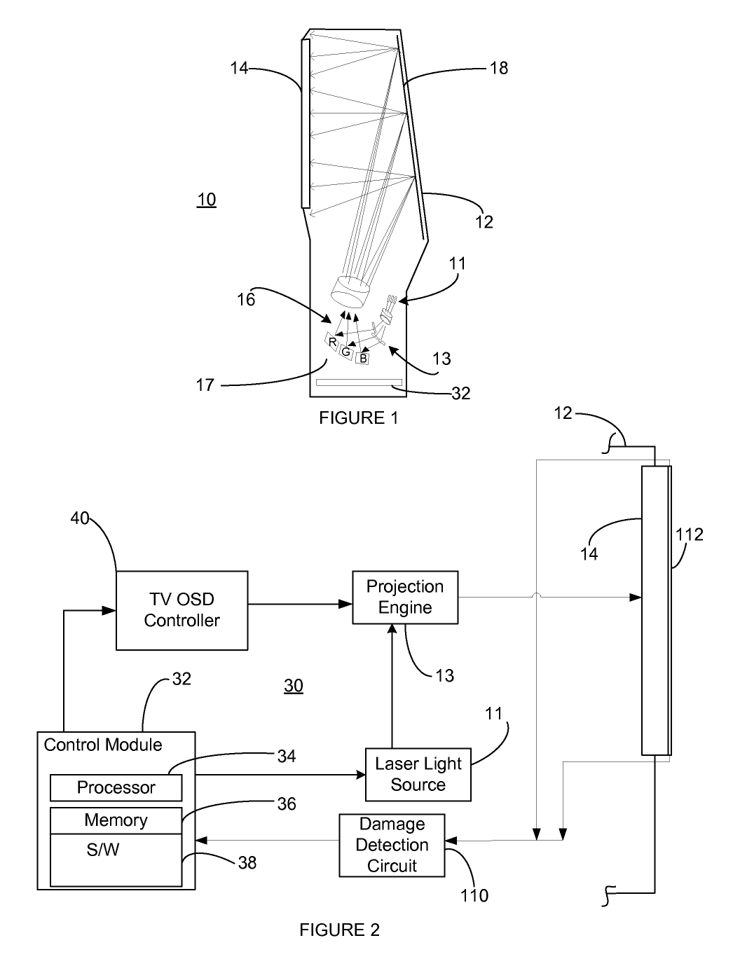

Turning in detail to the figures, FIG. 1 depicts a schematic of a laser projection television (PTV) 10. The PTV 10 comprises a cabinet or enclosure 12 housing an image projection engine or system 13, e.g., a DLP, LCD or LCOS based projection engine or the like, projection optics 16 coupled to the image engine 13, a laser light 11 source coupled to the image engine 13, a projection screen assembly 14 attached to the front of the cabinet 12, and a mirror 18 optically coupled to the projection screen assembly 14 and the image projection engine 13 and projection optics 16. Also mounted in the interior 17 of the cabinet 12 is a control module 32 comprising logic circuits and other electronic components.

Referring to FIG. 2, the PTV 10 preferably includes a control system 30 having a damage detection circuit 100 coupled to a conductive trace or film 110 formed on the screen 14 and also coupled to the control module 32. The control module 32 is also coupled to the television's on screen display (OSD) controller 42 and the laser light source 11. Both the OSD controller 42 and the laser light source 11 are coupled to the television's projection engine 13, which is operably coupled to the screen 14.

The control module 32 preferably comprises a microprocessor 34, non-volatile memory 36 and system software 38 stored in the memory 36. The software 38 preferably includes a set of instructions used to control the overall operation of the television 10 and, among other things, shut down the operation of the laser light source 11 in response to a laser enable signal received from the damage detection circuit 100.

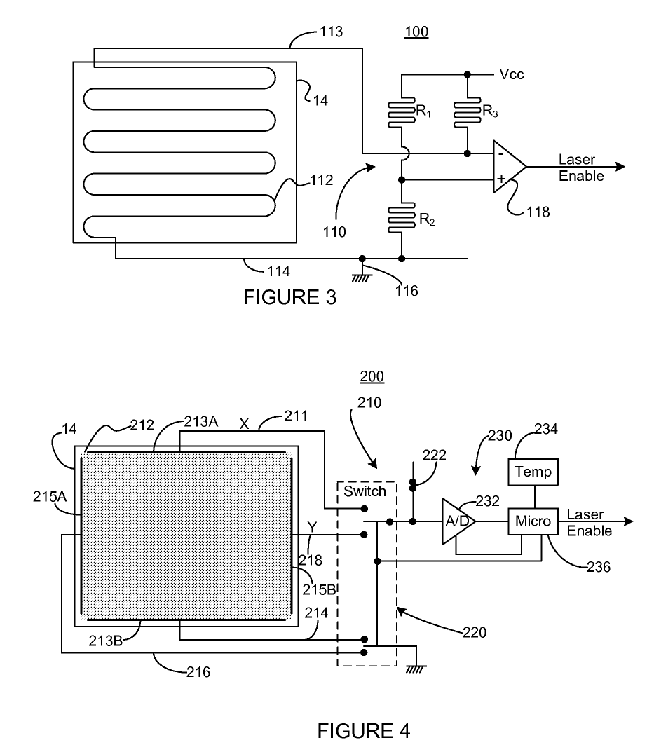

The damage detection circuit 110 detects a damaged screen due to impact or shock through the measure of continuity or resistivity of a conductive trace or coating 112 applied to the screen 14. In one embodiment, as depicted in FIG. 3, a damage detection system 100 comprises a clear, transparent or translucent conductive trace 112 preferably comprising indium tin oxide (ITO) or other clear, transparent or translucent conductive material and applied to the screen 14 preferably in a serpentine configuration. The pitch of the trace 112 is preferably less than half of the size of a hole or crack in the screen 14 to be detected. The damage detection circuit 110 includes a first lead 114 coupled to a first end of the trace 112 and connected to electrical ground 116. A second lead 113 coupled to the other end of the trace 112 is connected to a pull-up resistor R₃ to Vcc and a negative input of a comparator 118. The comparator 118 compares a reference voltage, which is created by divider resistors R₁ an R₂, on the positive input of the comparator 118 to the voltage on the negative input of the comparator 118. Damage to the screen 14 is detected when a hole or crack in the screen 14 is sufficiently large to open the conductive trace 112. With the trace 112 open, the pull-up resister R₃ will pull the negative input of the comparator 118 high and the output signal of the comparator 118 will go low as a result. The output laser enable signal is received and monitored by the control module 32, which will shut down the laser light source 11, turn off the power to the laser light source or disable a laser driver circuit to prevent excessive light output when a low output laser enable signal is received.

In another embodiment, as depicted in FIG. 4, a damage detection system 200 comprises a clear, transparent or translucent resistive coating or film 212, such as a thin metallic layer, applied to the screen 14. The damage detection circuit 210 includes electrodes 213 and 215 positioned adjacent the edges of the screen 14. Wire leads 211, 214, 216 and 218 are attached to the electrodes 213 and 215 to enable a change in resistance of the coating 212 to be measured in the X and Y axis to detect a damaged screen 14. A set of switches 220 connect the X or Y electrodes 213 and 215 to a comparator circuit 230 to measure the resistance of the coating 212. The resistance is measured by applying a fixed current through a suitable current source 222 and measuring the voltage drop across the electrodes with an analog-to-digital converter 232 and a microprocessor 236. The microprocessor 236 controls the set of switches 220 to sample the resistance in the X and Y axis and compares the sampled resistance to a stored or recorded normal resistance in the X and Y axis of the undamaged screen 14, to detect changes in the resistance of the coating 212 due to a crack or hole in the screen 14. The microprocessor 236 disables or shuts down the laser enable output signal when a change in resistance greater than a predetermined value is detected. The output laser enable signal is received and monitored by the control module 32, which will shut down the laser light source 11 turn off the power to the laser light source or disable a laser driver circuit to prevent excessive light output when a change in resistance greater than a predetermined value is detected.

A temperature sensor 234 can be connected to the microprocessor 236 to compensate for changes in the resistivity of the screen coating 212 due to ambient temperature changes.

In the foregoing specification, specific example embodiments have been described. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

1. A screen damage detection system for a laser PTV comprising
a conductive trace disposed on the surface of a display screen of the PTV, and
a damage detection circuit coupled to the conductive trace and configured to detect discontinuity in the conductive trace due to damage of the screen.

2. The system of claim 1 wherein the detected discontinuity is a function of the resistivity of the trace.

3. The system of claim 1 wherein the trace is formed from a transparent conductive material.

4. The system of claim 3 wherein the transparent conductive material is indium tin oxide (ITO).

5. The system of claim 1 wherein the trace is formed in a serpentine configuration.

6. The system of claim 1 wherein the pitch of the trace is less than one half of the smallest size of a hole, crack or chip in the screen to be detected.

7. The system of claim 1 wherein the circuit is adapted to cause the shut down of a laser light source when discontinuity in the trace is detected.

8. The system of claim 7 wherein the circuit comprises
a comparator,
a first lead coupled to a first end of the trace and connected to electrical ground,
a second lead coupled to a second end of the trace and to a negative input of the comparator,
a pull-up resistor connected to the second lead and a power source, and
first and second divider resisters connected to electrical ground and the power source and coupled in parallel to a positive input of the comparator,
wherein the comparator being adapted to compare a reference voltage created by divider resistors on the positive input of the comparator to the voltage on the negative input of the comparator.

9. The system of claim 8 wherein the pull-up resister is adapted to pull the negative input of the comparator high due to discontinuity in the trace.

10. The system of claim 8 wherein the comparator is adapted to output an output signal that corresponds to the high input on its negative input to signal a control system to shut down a laser light source.

11. A screen damage detection system for a laser PTV comprising
a resistive film disposed on a surface of a display screen of the PTV, and
a damage detection circuit coupled to the resistive film and configured to detect damage to the screen as a function of a change in resistivity of the film. 12. The system of claim 11 wherein the resistive film comprises a thin metallic layer.

12. The system of claim 11 wherein the film is formed from a transparent resistive material.

13. The system of claim 11 wherein the circuit detects a change in resistivity as a function voltage drop across the film.

14. The system of claim 11 wherein the circuit is adapted to cause the shut down of a laser light source when a change in resistivity is detected.

15. The system of claim 14 wherein the circuit comprises
a first set of electrodes positioned along the side edges of the screen,
a second set of electrodes positioned along the top and bottom edges of the screen,
a comparator circuit,
a switch coupled to the comparator circuit,
a current source coupled to the comparator and the switch, and
first and second sets of wire leads coupled to the first and second set of electrodes and the set of switches.

16. The system of claim 15 wherein the switch comprises a set of switches.

17. The system of claim 16 wherein the comparator circuit comprises an analog-to-digital converter and a microprocessor, the microprocessor records the normal resistance of screen in an undamaged state along the axis extending between the electrodes of the first and second sets of electrodes, controls the set of switches to sample the resistance along each axis to detect changes in the resistance of the film and outputs a disable signal when a change in resistance greater than a predetermined value is detected.

18. The system of claim 17 wherein the comparator circuit comprise a temperature sensor coupled to the microprocessor.
